(19) United States
(12) Patent Application Publication
(10) Pub. No.: US 2013/0179798 A1
(43) Pub. Date: Jul. 11, 2013

(54) APPLICATION DISSEMINATION AND FEEDBACK

(71) Applicants: Rao Y. Korupolu, Hyderabad (IN); Rajalakshmi Dani, Redmond, WA (US); Jenny Snehalatha S., Hyderabad (IN); Anirudh Goel, Hyderabad (IN); Renjith Varma, Bangalore (IN)

(72) Inventors: Rao Y. Korupolu, Hyderabad (IN); Rajalakshmi Dani, Redmond, WA (US); Jenny Snehalatha S., Hyderabad (IN); Anirudh Goel, Hyderabad (IN); Renjith Varma, Bangalore (IN)

(73) Assignee: MICROSOFT CORPORATION, Redmond, WA (US)

(21) Appl. No.: 13/344,965

(22) Filed: Jan. 6, 2012

(51) Int. Cl. G06F 3/01

(52) U.S. Cl. 715/745

(57) ABSTRACT

Application dissemination and feedback is described. In one or more implementations, a system includes a developer portal module that is accessible as a network service via an Internet to expose a user interface, as part of a developer portal. The developer portal module includes an application coding module configured to code an application through interaction with the user interface and an application deployment module configured to accept one or more inputs via the user interface to specify how the application is to be deployed over the Internet for local execution by one or more users. The developer portal module also includes a feedback manager module to configure the application automatically and without user intervention to collect feedback from the one or more users regarding the local execution of the application.

### BACKGROUND

The number of applications that are made available to consumers continues to expand with the advent of online application marketplaces. Consumers, for instance, may be able to access tens of thousands and even hundreds of thousands of applications from a single application marketplace.

However, conventional techniques that were made available to developers to code, disseminate, and collect feedback, even if available at all, were often rigid and could even result in the loss of rights to the application, e.g., due to uncontrolled dissemination. Consequently, developers often choose to forgo these conventional techniques in the development of the applications, which could also result in inefficiencies and developer frustration.

### SUMMARY

Application dissemination and feedback is described. In one or more implementations, a system includes a developer portal module that is accessible as a network service via an Internet to expose a user interface as part of a developer portal. The developer portal module includes an application coding module configured to code an application through interaction with the user interface and an application deployment module configured to accept one or more inputs via the user interface to specify how the application is to be deployed over the Internet for local execution by one or more users. The developer portal module also includes a feedback manager module to configure the application automatically and without user intervention to collect feedback from the one or more users regarding the local execution of the application without leaving the application context.

In one or more implementations, a user interface is exposed of a developer portal, implemented by one or more computing devices, for access via a network that is configured to permit coding and tracking of applications by a developer for dissemination as part of an application marketplace maintained as part of the developer portal. Feedback is output, via the user interface, that is collected from local execution of the application caused by a plurality of users, the feedback collected by the developer portal such that feedback provided by one user is not viewable by another user that also provided feedback.

In one or more implementations, coding functionality is exposed, which is accessible via a user interface of a developer portal that is implemented using one or more computing devices. The coding functionality is configured to code and track development of an application through interaction with the user interface. Deployment functionality is also exposed that is accessible as part of the user interface to specify how the application is to be deployed over an Internet for local execution by one or more users. Further, feedback functionality is exposed that is accessible as part of the user interface that is configured to automatically aggregate and rank feedback collected through the local execution by the one or more users. The feedback is collected via a mechanism that is included automatically and without user intervention as part of the application by the developer portal before deployment of the application.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to perform application dissemination and feedback techniques as part of a developer portal.

FIG. 2 is an illustration of a system in an example implementation showing a developer portal module of FIG. 1 in greater detail.

FIG. 3 depicts an example implementation of a user interface output as part of a developer portal of FIG. 2 that is usable to develop an application.

FIG. 4 depicts an example implementation of a user interface of an application deployed in FIG. 3 as including a mechanism by which a user may provide feedback within a context of the application.

FIG. 5 depicts an example implementation of a user interface that is output by a developer portal for viewing by a developer that includes feedback collected via FIG. 4 that is aggregated and ranked.

FIG. 6 is a flow diagram depicting a procedure in an example implementation in which a user interface of a developer portal is exposed to output feedback from a module that was automatically incorporated as a part of the application by the portal.

### DETAILED DESCRIPTION

### Overview

Conventional techniques that were utilized to develop applications did not include a mechanism by which developers could keep track of applications that were being developed. For example, these conventional techniques did not address the various stages involved in the development of the respective applications.

Further, conventional techniques did not provide a mechanism by which developers could collect feedback regarding the application. Consequently, developers were often forced to perform these tasks manually, such as by sending email, file sharing, and so on, which could even have an effect on confidentiality of the application. Therefore, developers often went to extremes, such as by manually sharing the application with a small set of trusted people (and thereby preserving confidentiality of the application) or exposing the application widely on a bulletin board which could cause loss of confidentiality and often ineffectual feedback.

Application dissemination and feedback techniques are described. In one or more implementations, a developer portal is provided as part of a network service. The developer portal is configured to include functionality via which a developer may code an application for dissemination, such as in an application marketplace associated with the developer portal. This functionality may include a feature to track development of the application, which may include coding, testing, dissemination, and use of the application.

The developer portal may also include functionality such that the developer may control dissemination of the application, such as to test the application by others inside and/or outside a developer's organization as specified by the developer. Thus, a developer may readily test the application yet preserve confidentiality of the application.

The developer portal may further include functionality relating to feedback regarding the application. For example, the developer portal may include a mechanism to be included as part of the application automatically and without user intervention on the part of the developer. This mechanism may be configured to collect user feedback during local execution of the application as specified by one or more users. Additionally, the feedback may be collected by the mechanism within the context of the application, and therefore support rich and timely feedback from the one or more users.

The developer portal may be configured to collect this feedback and expose it to the developer, such as by aggregating and ranking the feedback for output in a user interface. The feedback may be collected at a variety of stages, such as during the development and later public dissemination of the application. In one or more implementations, this feedback is collected by the developer portal such that it is not accessible to other users, thereby preserving anonymity and encouraging detailed and lengthy comments. Further discussion of these and other application dissemination and feedback techniques may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

### Example Environment

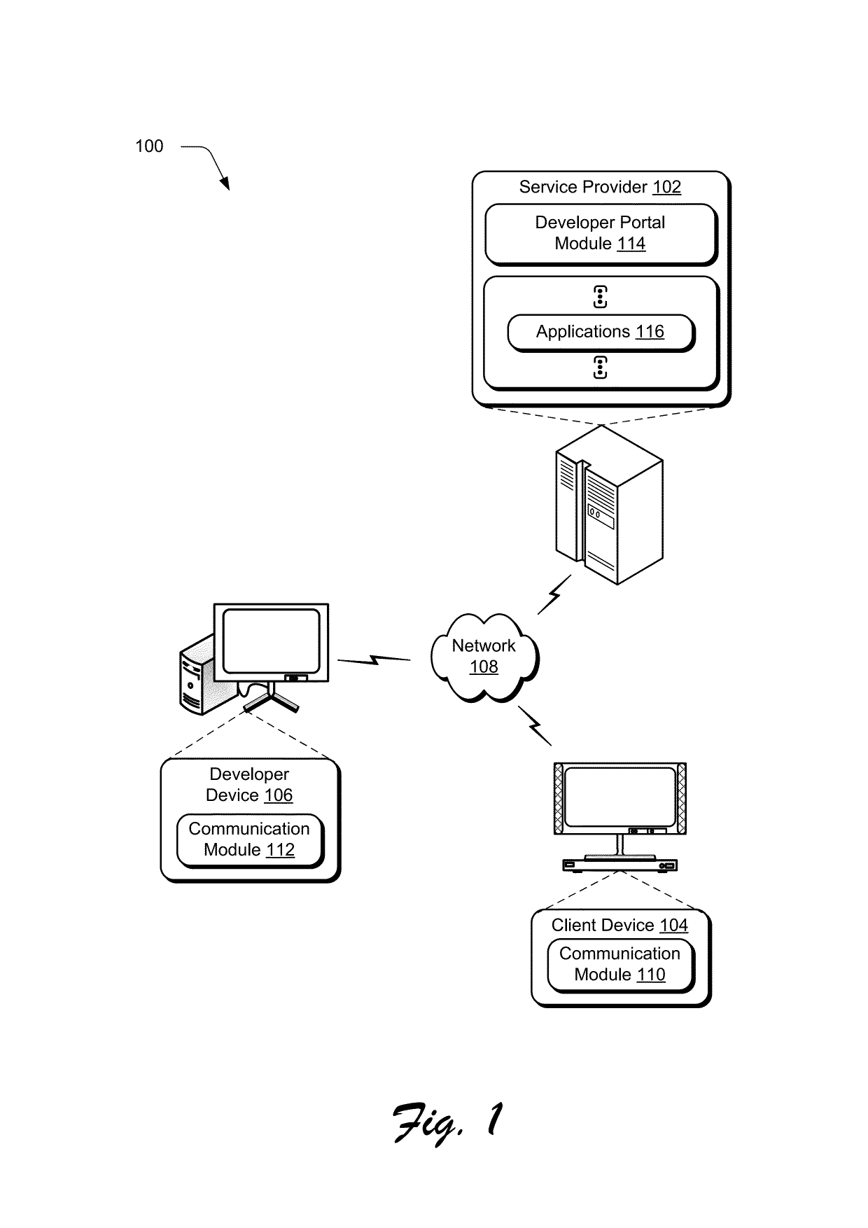

FIG. 1 is an illustration of an environment 100 in an example implementation that is operable to employ application dissemination and feedback techniques described herein. The illustrated environment 100 includes a service provider 102, a client device 104, and a developer device 106 that are communicatively coupled, one or another, via a network 108. The service provider 102, client device 104, and developer device 106 may be implemented as a variety of different computing devices.

For example, a computing device may be configured as a computer that is capable of communicating over the network 108, such as a desktop computer, a mobile station, an entertainment appliance, a set-top box communicatively coupled to a display device, a wireless phone, a game console, and so forth. Thus, a computing device may range from full resource devices with substantial memory and processor resources (e.g., personal computers, game consoles) to a low-resource device with limited memory and/or processing resources (e.g., traditional set-top boxes, hand-held game consoles). Additionally, although a single computing device is shown in the illustrated example for the service provider 102, client device 104, and developer device 106, the computing device may be representative of a plurality of different devices, such as multiple servers utilized by a business to perform operations such as by the service provider 102, a remote control and set-top box combination, an image capture device and a game console configured to capture gestures, and so on.

Although the network 108 is illustrated as the Internet, the network may assume a wide variety of configurations. For example, the network 108 may include a wide area network (WAN), a local area network (LAN), a wireless network, a public telephone network, an intranet, and so on. Further, although a single network 108 is shown, the network 108 may be configured to include multiple networks.

The client device 104 and the developer device 106 are further illustrated as including respective communication modules 110, 112. The communication modules 110, 112 are representative of functionality of the respective device to communicative via the network 108, such as to access network services of the service provider 102. Accordingly, the communication modules 110, 112 may be configured in a variety of ways, such as a stand-alone application (e.g., browser), functionality that is part of another application (e.g., a network-enabled application), a third party plugin module, and so forth.

The service provider 102 is illustrated as including a developer portal module 114. The developer portal module 114 is representative of functionality to provide network services as part of a developer portal to develop one or more applications 116. For example, these network services may be provided via a free developer site to a developer using the developer device 106 to code, debug, and test applications 116. Additionally, the developer portal module 114 may be configured to automatically add an application to a list upon development and may even be used to track the application 116 through deployment.

Using this functionality, the developer can share the application 116 with other users both inside and outside an organization to review the application as specified by the developer. The developer portal module 114 may also include functionality to automatically enable a feedback feature to an application 116 deployed by the developer portal module 114.

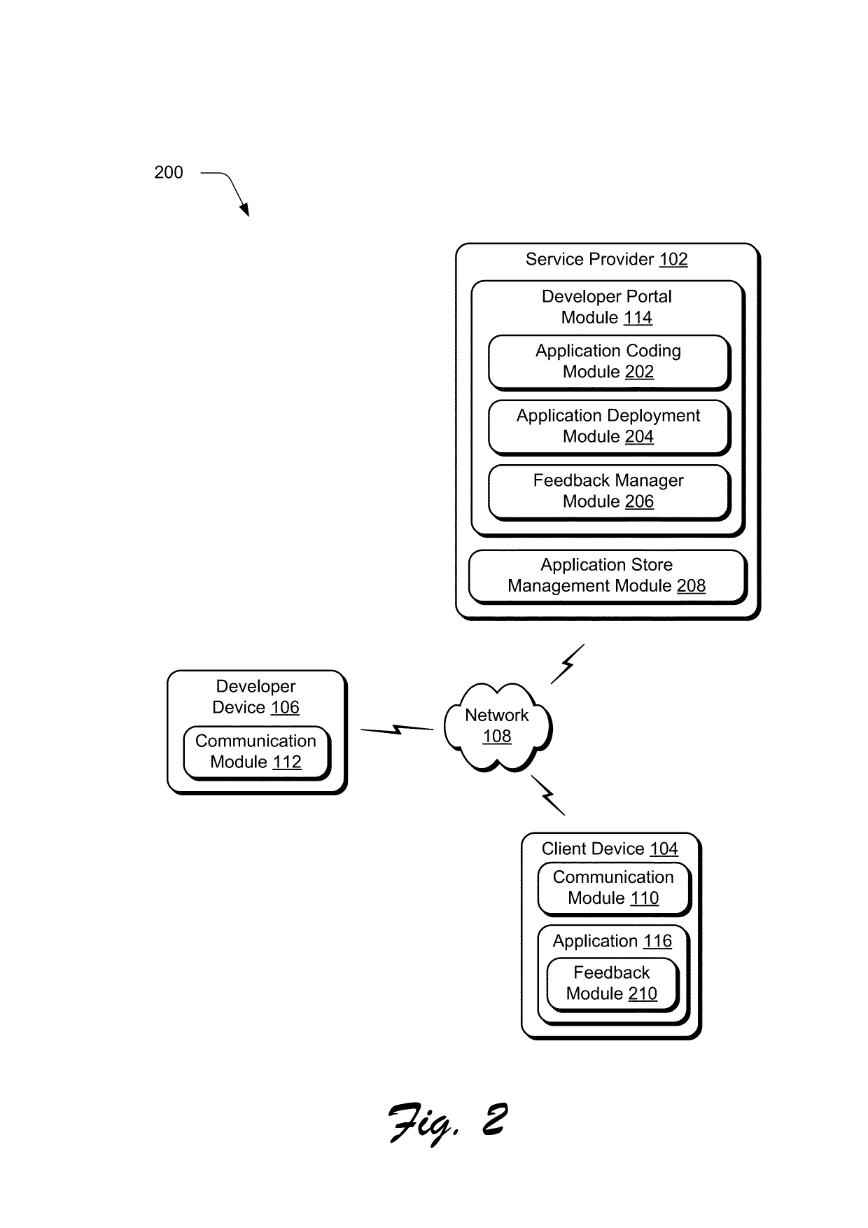

The functionality may enable a user to provide feedback during local or remote execution of the application, e.g., by clicking on an appropriate control. This feedback may be collected by the developer portal module 114 for review by the developer. In one or more implementations, users of the client device 104 that provide feedback do not have access to the collected feedback or other parts that are particular to the developer's access with the service provider. The users are also not also able to access the application 116 package, thereby promoting confidentiality of the application 116. However, it should be readily apparent that other implementations are also contemplated in which access to feedback and/or the application package is permitted. Further discussion of application dissemination and feedback techniques may be found in relation to FIG. 2.

Generally, any of the functions described herein can be implemented using software, firmware, hardware (e.g., fixed logic circuitry), or a combination of these implementations. The terms “module,” “functionality,” and “engine” as used herein generally represent software, firmware, hardware, or a combination thereof. In the case of a software implementation, the module, functionality, or engine represents program code that performs specified tasks when executed on a processor (e.g., CPU or CPUs) and is storable in one or more computer readable storage devices and thus is implementable at least partially in hardware. The features of the techniques described below are platform-independent, meaning that the techniques may be implemented on a variety of commercial computing platforms having a variety of processors.

For example, a computing device may also include an entity (e.g., software) that causes hardware of the computing device to perform operations, e.g., processors, functional blocks, and so on. For example, the computing device may include a computer-readable medium that may be configured to maintain instructions that cause the computing device, and more particularly hardware of the computing device to perform operations. Thus, the instructions function to configure the hardware to perform the operations and in this way result in transformation of the hardware to perform functions. The instructions may be provided by the computer-readable medium to the computing device through a variety of different configurations.

One such configuration of a computer-readable medium is signal bearing medium and thus is configured to transmit the instructions (e.g., as a carrier wave) to the hardware of the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

FIG. 2 is an illustration of a system 200 in an example implementation showing the developer portal module 114 in greater detail. The system 200 includes the service provider 102, client device 104, and developer device 106 of FIG. 1. As previously described, a developer using the developer device 106 may access a developer portal implemented by the developer portal module 114 to interact with one or more network services that may relate to the coding, deployment, and feedback relating to the application 116. This functionality is represented by an application coding module 202, an application deployment module 204, and a feedback manager module 206 of the developer portal module 114. The service provider 102 is also illustrated as including an application store management module 208, which is representative of functionality to manage an application store that is available via the network 108.

The application coding module 202, for instance, is representative of functionality that is exposed to a developer using the developer device 106 to code an application 116. An example of this is Visual Studio which may be accessed via the developer portal to write code. It should be readily apparent, however, that a wide variety of different types of coding functionality that support a wide variety of different types of code may also be supported by the application coding module 202 without departing from the spirit and scope thereof.

The application deployment module 204 is representative of functionality that is accessible by a developer through the developer portal to specify how the application 116 is to be deployed. For example, the application deployment module 204 may be configured to accept an identification of a particular organization (e.g., a particular domain name), user logins to the application marketplace, and so on. In this way, the application deployment module 204 may support functionality that may be used to deploy the application for testing purposes. In one or more implementations, the application deployment module 204 may include functionality to provide a nondisclosure agreement to users that are to receive the application 116, e.g., for testing. Upon receipt of a completed nondisclosure agreement, the application deployment module 204 may make the application available to the users, thereby preserving confidentiality and associated rights that pertain to the application 116.

The application deployment module 204 may also support functionality to expose the application for deployment as part of the application marketplace. The application deployment module 204 may further support functionality to output information in the user interface of the developer portal that may be used to track this deployment, such as for instances in which the developer has coded and deployed a plurality of applications 116.

The feedback manager module 206 is representative of functionality that is accessible by the developer through the developer portal to collect feedback regarding the application 116. The feedback manager module 206, for instance, may include functionality to cause a feedback module 210 to be included automatically and without user intervention as a part of an application 116 being deployed by the developer portal.

The feedback module 210 may be configured for execution as part of the application 116, e.g., during local execution at a client device 104, to provide a mechanism by which users may provide feedback regarding the execution of the application 116. Further, this feedback module 210 may be incorporated at a variety of points in a lifecycle of the application 116, such as during testing, as part of deployment in an application marketplace, and so on. In this way, the developer may be provided with a mechanism for collecting and viewing the feedback relating to the application 116. The feedback may be collected and output in a variety of ways for viewing by the developer, and example of which may be found in relation to the following figures.

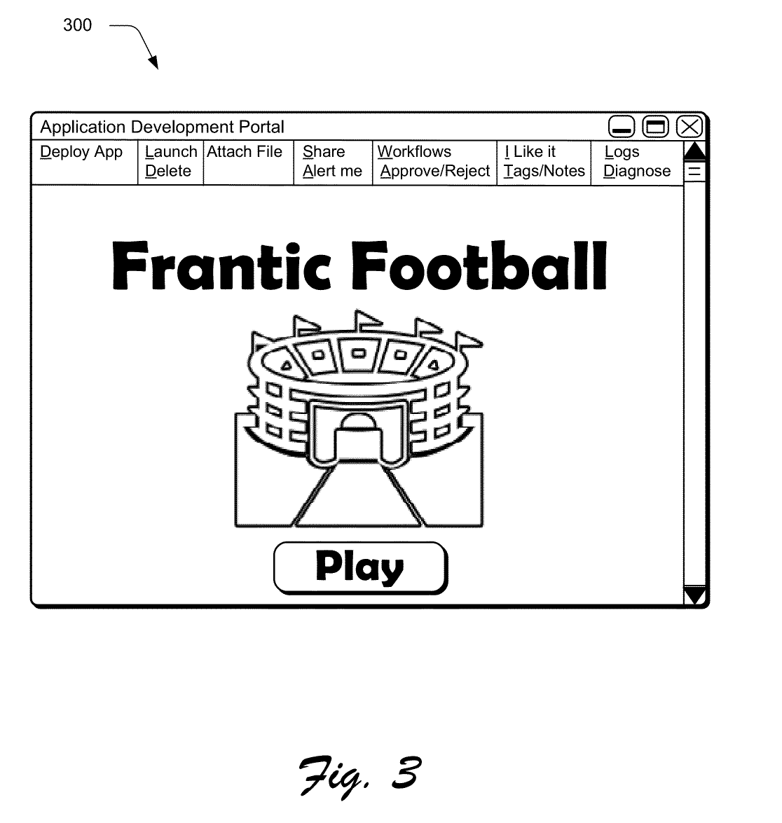

FIG. 3 depicts an example implementation of a user interface 300 output as part of a developer portal of FIG. 2 that is usable to develop an application. The user interface 300 is this example is output by the developer portal module 114 of the service provider 102 for display on a display device of a developer device 106 of the developer.

As illustrated, the user interface 300 includes a variety of functionality that is exposed for use by the developer. Examples of this functionality include an ability to deploy an application 116, launch or delete an application 116, attach a file, share or set one or more settings relating to alerts regarding the application, workflows (e.g., to track a product lifecycle of the application 116), an ability to approve or reject changes (e.g., made by other members of a development team), an ability to indicate particular portions of the application are liked as well as to tag or add notes to these portions, logs regarding the development (e.g., testing) of the application 116, an ability to diagnose errors in the execution of the application 116, and so on.

In the illustrated instance, the application 116 is a football game that is to be made available via an application marketplace although it should be readily apparent that a wide variety of other instances are also contemplated. The application 116 may be deployed through use of the application deployment module 204 for testing by one or more users that are specified by the developer as previously described.

Accordingly, before deployment the feedback manager module 206 may configure the application 116 to include a feedback module 210 that may be executed as part of the application 116, e.g., locally by a client device 104 as shown in FIG. 2. The feedback module 210 may be configured to include a mechanism by which a user may provide feedback to be automatically communicated back to the service provider 102, an example of which is shown in the following figure.

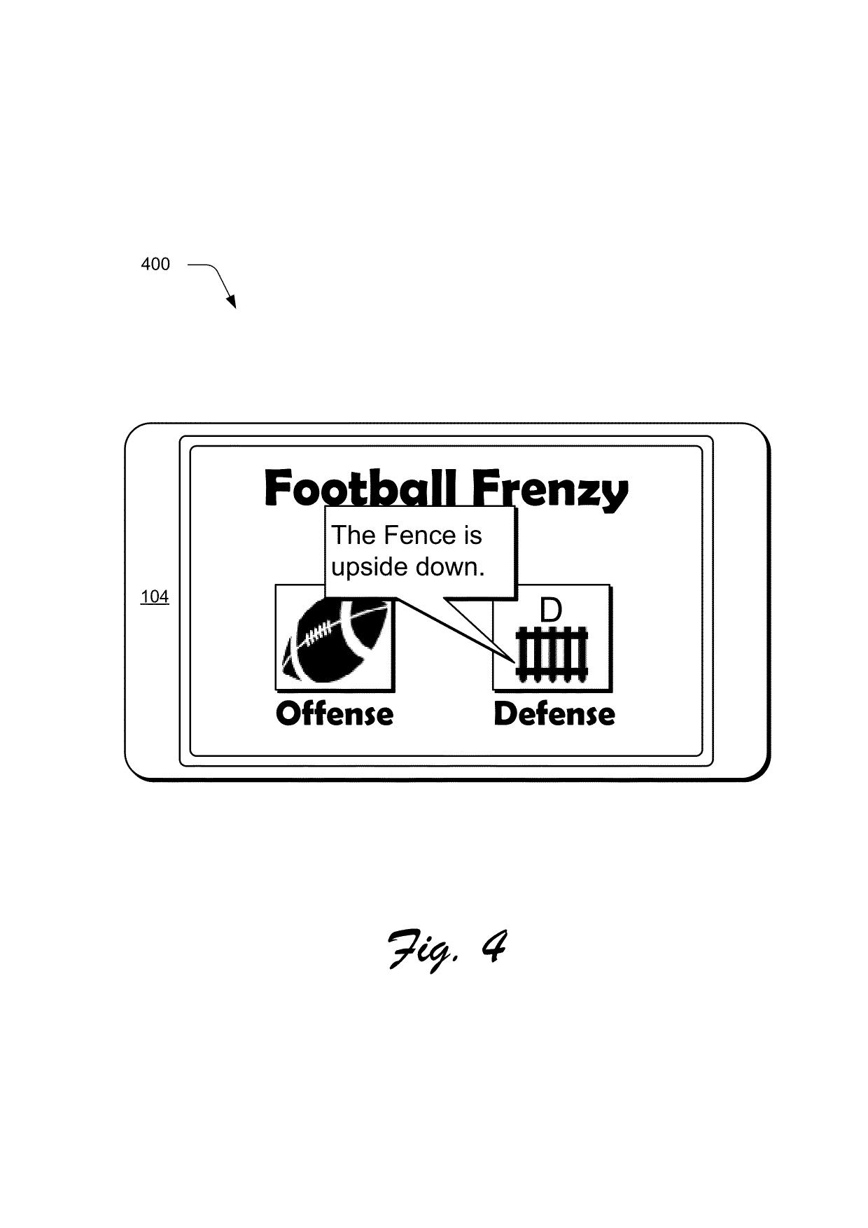

FIG. 4 depicts an example implementation of a user interface 400 of the application 116 deployed in FIG. 3 as including a mechanism by which a user may provide feedback within a context of the application 116. In the illustrated example, the client device 104 is configured as a mobile device that executes the application 116 deployed by the developer.

The mechanism in the illustrated instance is configured to be output within the context of the application 116, such that the mechanism may accept inputs from a user to provide feedback and view the user interface of the application concurrently. Thus, a user is not forced to navigate away from the application 116 and therefore may provide timely feedback regarding the application 116. In this way, richer feedback is promoted by the mechanism by remaining “current” with the user's experience. The mechanism may be output in a variety of ways, such as through selection in a menu, output in response to a gesture, and so forth.

In one or more implementations, a context of the feedback within the application 116 may also be automatically stored by the feedback module 210. In the illustrated instance, the feedback indicates that a fence displayed as part of a control is displayed “upside down.” In this implementation, the feedback module 210 may also store information that indicates that the feedback is related to the particular control. In this way, the information automatically stored by the feedback module 210 may help to provide relevancy to the feedback, which is useful in situations where the relevancy is difficult to determine based on the text included in the feedback by itself.

Although a context defined in relation to a control was discussed in this example, it should be readily apparent that a wide variety of contexts may also be described, such as a particular view within the user interface (e.g., a particular page), in relation to a particular item displayed within the user interface, and so on. Further, it should also be apparent that a variety of other implementations are also contemplated, such as implementations that rely solely on the text of the feedback. This feedback may then be communicated by the feedback module 210 to the service provider 102 for output to the developer, an example of which is described in relation to the following figure.

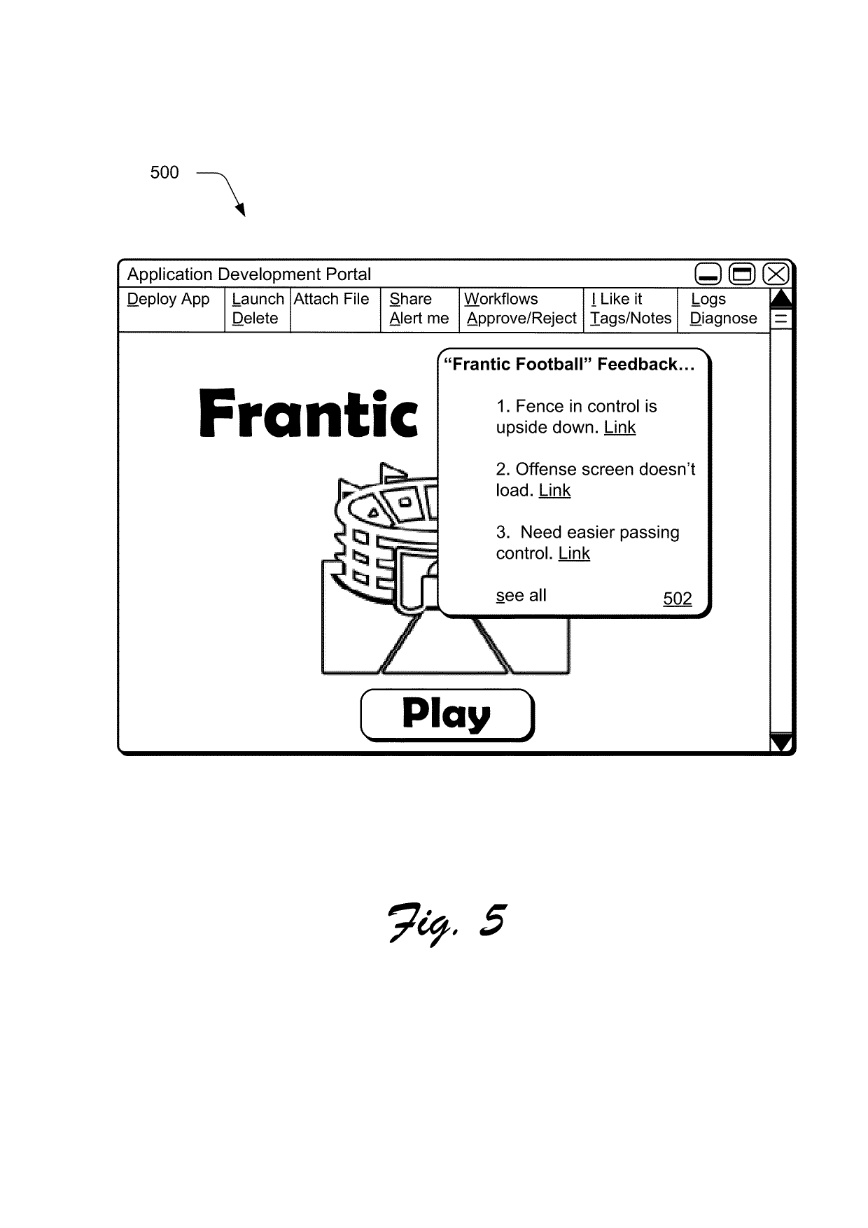

FIG. 5 depicts an example implementation of a user interface 500 that is output by a developer portal for viewing by a developer that includes feedback collected via FIG. 4 that is aggregated and ranked. In this example, a portion 502 of the user interface 500 (e.g., a pop-up menu) is displayed for viewing by the developer. The portion 502 includes feedback that has been aggregated and ranked by the feedback manger module 208, which was collected from a plurality of different client devices 104.

The feedback may be aggregated and ranked in a variety of ways. For example, the feedback manager module 208 may include functionality to examine text included in the feedback and group the feedback based on commonalities detected in the text. In another example, the feedback may be aggregated based on a context described by information included with the feedback by the feedback module 210. This may include relevancy to a particular control, view of the user interface, item in the user interface, and so on.

This feedback may then be ranked for viewing by the developer, which again may be performed in a variety of ways. For example, the feedback may be ranked based on a number of occurrences, e.g., number of items of feedback that have common keywords. The feedback may also be ranked based on a defined prioritization, e.g., rank feedback relating to controls over items in the user interface, rank feedback that relates to specific features over non-specific feedback (e.g., rank feedback relating to a particular control over feedback stating “awesome game”), and so forth. In this way, the developer may be given a concise description of the feedback that was collected automatically for the application 116.

As illustrated, the feedback in the portion 502 may also include links, such as to view the original comments, particular portions of the application 116 that pertain to the feedback, and so forth. As previously described, the feedback may be limited to exposure to the developer such that users may not view feedback that was not provided by the user, thereby preserving anonymity of the users and promoting detailed feedback, although other examples are also contemplated. The menu 502 may also display a user identifier of a user who provided the feedback, such as support follow-up if desires. Further discussion of application dissemination and feedback techniques may be found in relation to the following procedures.

### Example Procedures

The following discussion describes application dissemination and feedback techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1, the system 200 of FIG. 2, and the user interfaces 300-500 of FIGS. 3-5.

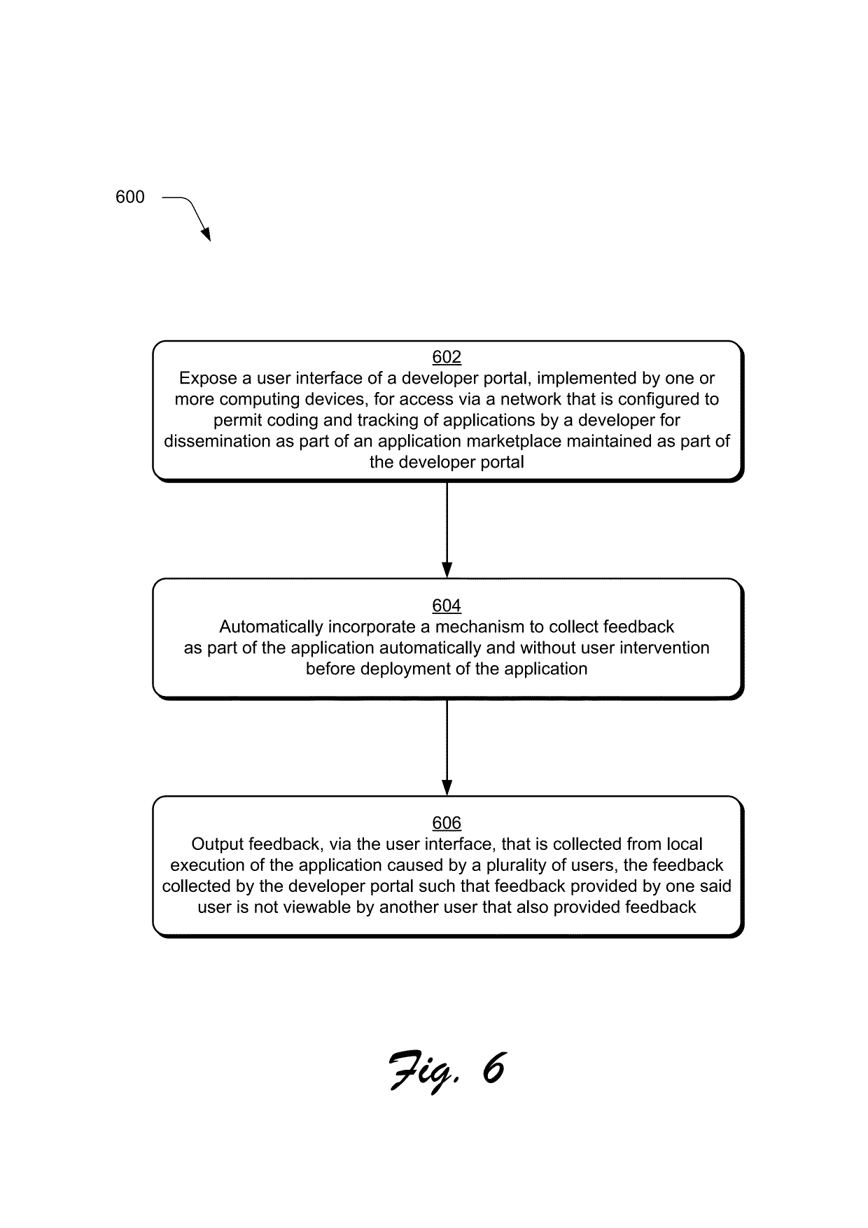

FIG. 6 depicts a procedure 600 in an example implementation in which a user interface of a developer portal is exposed to output feedback from a module that was automatically incorporated as a part of the application by the portal. A user interface is exposed of a developer portal, implemented by one or more computing devices, for access via a network that is configured to permit coding and tracking of applications by a developer for dissemination as part of an application marketplace maintained as part of the developer portal (block 602). The developer portal, for instance, may include a variety of different functionality that is exposed to a user of the developer device 106 to code and deploy applications, which may include testing, tracking, and feedback.

A mechanism is automatically incorporated to collect feedback as part of the application automatically and without user intervention before deployment of the application in the application (block 604). The mechanism, for instance, may be implemented as a feedback module 210 that is included as part of the code of an application 116 by the feedback manager module 206. The feedback module 210 may be configured to collect user feedback within a context of the execution of the application 116 and communicate that feedback back to the service provider 102 via the network 108. In one or more implementations, this feedback is kept confidential between the user that provided the feedback and the developer such that the feedback is not viewable by other users, although other implementations are also contemplated.

Feedback is output, via the user interface, that is collected from local execution of the application caused by a plurality of users, the feedback is collected by the developer portal such that feedback provided by one user is not viewable by another user that also provided feedback (block 606). The user interface, for instance, may aggregate and rank the feedback as previously described for viewing by the developer. Further, this feedback may continue past a testing stage through actual deployment of the application 116 to the public, e.g., as part of the application store. In this way, the developer may track a lifecycle of the application 116 through development and public deployment and receive feedback regarding the application. A variety of other examples are also contemplated as previously described.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A system comprising:
a developer portal module that is accessible as a network service via an Internet to expose a user interface, as part of a developer portal, that is configured to access:
an application coding module configured to code an application through interaction with the user interface;
an application deployment module configured to accept one or more inputs via the user interface to specify how the application is to be deployed over the Internet for local execution by one or more users; and
a feedback manager module to configure the application automatically and without user intervention to collect feedback from the one or more users regarding the local execution of the application.

2. A system as described in claim 1, wherein the application coding module is configured to indicate a relative stage of development of the application.

3. A system as described in claim 1, wherein the one or more inputs accepted by application deployment module specify particular users of an application marketplace maintained by the developer portal module that are permitted to access the application.

4. A system as described in claim 1, wherein the feedback manager module is configured to output a mechanism that is accessible to the one or more users during the local execution of the application such that the mechanism and a user interface of the application are viewable concurrently by the one or more users.

5. A system as described in claim 4, wherein the feedback manager module is configured to incorporate the mechanism as part of the application automatically and without user intervention before deployment of the application by the deployment module.

6. A system as described in claim 4, wherein the mechanism is configured to be output in a context of the user interface of the application to which the feedback relates.

7. A system as described in claim 6, wherein the context is a particular one of a plurality of views that are output as part the user interface, a particular one of a plurality of items that are part of the user interface, or a particular one of a plurality of controls that are part of the user interface.

8. A system as described in claim 7, wherein the mechanism is configured to automatically associate data without user intervention with the feedback provided by the one or more users such that a user interface output by the feedback manager module includes the feedback and the associated data that describes the context.

9. A system as described in claim 1, wherein the feedback manager module is configured to aggregate feedback from the one or more users and output this feedback in a user interface that is accessible to a developer of the application.

10. A system as described in claim 1, wherein the feedback manager module is configured to collect feedback regarding the local execution of the application during testing of the application as well as after the application is made publically available via an application marketplace that is maintained as part of the application development portal.

11. A system as described in claim 1, wherein the feedback manager module is configured to collect feedback from the one or more users regarding the local execution of the application and expose the feedback to the developer without exposing the feedback to other said users such that feedback from one said user is not viewable by another said user that provided feedback.

12. A method comprising:
exposing a user interface of a developer portal, implemented by one or more computing devices, for access via a network that is configured to permit coding and tracking of applications by a developer for dissemination as part of an application marketplace maintained as part of the developer portal; and
outputting feedback, via the user interface, that is collected from local execution of the application caused by a plurality of users, the feedback collected by the developer portal such that feedback provided by one said user is not viewable by another user that also provided feedback.

13. A method as described in claim 12, wherein the feedback is configured to be collected via a mechanism that is accessible to respective said users during the local execution of the application such that the mechanism and a user interface of the application are viewable concurrently by the one or more users.

14. A method as described in claim 13, further comprising automatically incorporating the mechanism as part of the application automatically and without user intervention before deployment of the application in the application marketplace.

15. A method as described in claim 13, wherein the mechanism is configured to be output in a context of the user interface of the application to which the feedback relates.

16. A method as described in claim 15, wherein the context is a particular one of a plurality of views that are output as part the user interface, a particular one of a plurality of items that are part of the user interface, or a particular one of a plurality of controls that are part of the user interface.

17. A method as described in claim 16, wherein the mechanism is configured to automatically associate data without user intervention with the feedback provided by the one or more users such that a user interface output by the feedback manager module includes the feedback and the associated data that describes the context.

18. A method as described in claim 13, further comprising aggregating and ranking the feedback for the outputting, the ranking based on commonality of the feedback, one to another.

19. A method comprising:
exposing coding functionality, which is accessible via a user interface of a developer portal that is implemented using one or more computing device, configured to code and track development of an application through interaction with the user interface;
exposing deployment functionality that is accessible as part of the user interface to specify how the application is to be deployed over an Internet for local execution by one or more users; and
exposing feedback functionality that is accessible as part of the user interface that is configured to automatically aggregate and rank feedback collected through the local execution by the one or more users, the feedback collected via a mechanism that is included automatically and without user intervention as part of the application by the developer portal before deployment of the application.

20. A method as described in claim 19, wherein the exposed feedback functionality of the developer portal is not accessible by the one or more users such that the one or more users are unable to view feedback regarding the application that is not provided by the user.
